(19) United States
(12) Patent Application Publication
(10) Pub. No.: US 2009/0309759 A1
(43) Pub. Date: Dec. 17, 2009

(54) Car-finder method and aparatus

(76) Inventor: Darin Scot Williams, Tucson, AZ (US)

Correspondence Address: DARIN WILLIAMS, 11265 E. CHUCKWAGON CIRCLE, TUCSON, AZ, 85749, US

(21) Appl. No.: 12/157,889

(22) Filed: Jun. 13, 2008

(51) Int. Cl. G08G 1/14

(52) U.S. Cl. 340/932.2

(57) ABSTRACT

One of the persistent irritations of daily life is forgetting where you parked your car. In small lot, this is merely annoying. When there are multiple lots a mile or more apart, and it is impractical to park in the same spot every time, finding one's car can become a major waste of time. The car-finder overcomes these difficulties by using an existing GPS-enabled (or otherwise location sensing) device, such as a cell phone, automatically identifying recent parking locations used by the user, allowing the user to select among them, and guiding the user to the parked vehicle.

This application claims the benefit of provisional patent application 60/849,055 filed Oct. 2, 2007.

### STATEMENT REGARDING FEDERALLY FUNDED R&D

No federal R&D funds were used in the development of this invention.

### REFERENCE TO LIST OR CD APPENDIX

Not applicable.

### BACKGROUND OF THE INVENTION

1. Field of the Invention

This invention relates to automatic location of misplaced vehicles.

2. Description of Prior Art

The problem is that many people tend to be absent minded: it is only when trying to return one's parked car that one realizes, “Parked where??” When the parking lot is small, the problem is easily overcome with a bit of searching. In larger lots the problem becomes more serious, and help is needed.

Many solutions are sold or have been proposed for helping one to find a misplaced vehicle, but all are inadequate because they suffer from some combination of the following limitations:
They work only in close proximity to the vehicle (limited range).
They require action before one realizes that one's car is missing (such as marking the position).
They requiring additional hardware (in the car or on the user).
They require an additional service infrastructure.

Perhaps the most common solution is using the car's keyless-entry key fob. Many of us have pressed the button and listened for the car's horn, or looked for the lights, while walking around a parking lot. When you know the car's approximate location this works fine. But, this solution is only viable within a few yards (transmitter range limitations), plus the distance that you're willing to walk. Even if the range were increased, this approach is only useful when you are close enough to see the lights or hear the horn. In many real situations, such as widely spaced noisy mall parking lots, this is not viable.

Various patents, including U.S. Pat. No. 5,786,758 Bullock and U.S. Pat. No. 5,089,803 Bohn, have attempted variations on the same theme, using different visual or auditory aids that are activated on user command. They suffer the same fundamental limitation, but are even more complex than the key fob.

One obvious solution is to use the “track” capability of a typical GPS unit. This keeps a record, like a snail trail, of the user's path. In some cases the trail also records the time corresponding to each position. While this approach can be used, it is awkward in that the user must look at the trail to decide which point indicates the car location. This can be quite difficult. Partial relief can be provided with a map overlay, but this typically includes streets, but not the parking lot layout. Overhead imagery provides more help, but this is still an awkward approach for the user.

It has been suggested in various forums, including www.halfbakery.com, that this problem can be solved by having the user carry a GPS and mark a waypoint where the car is parked. But, if one could remember to mark a waypoint, one could just have well written the car location in a note, rendering the GPS unnecessary. This approach is a non-starter for practicality.

A more viable suggestion was incorporating GPS into the keyless-entry key fob, so the position is automatically marked when the lock button is pushed. However, while GPS costs are dropping continually, this is well beyond the current cost tolerance for such items (careers have been damaged over adding pennies to the cost of the keyless entry device). Also, such devices have no built in mechanism that would allow cueing the user toward the car.

A completely different class of solutions, as US 20050231335 Miller, keeps the position finding unit or GPS with the vehicle, and transmits the data to another system which can then find the car for the user. This is the most viable of the current solutions, but is still burdensome for the individual user. It makes the user depended upon an external service and infrastructure, typically with an associated fee-for-use. It is completely non-usable when the car is parked in an area masked from communications. Of more concern from the perspective of some people, this approach is an invasion of privacy, in that it provides some outside agency with the ability to locate the user's car, without the user's knowledge or consent. From a user's point of view, one can do much better.

### SUMMARY

In accordance with the present invention, the position and velocity of a person (user) is monitored and processed to identify and record transitions from driving or riding in a vehicle to walking. In the best mode, this is done by software in a device already carried by the user, such as a GPS-capable cell phone. Transitions from driving to walking occur when parking the vehicle, and moving away on foot, and indicate where the vehicle was parked. When the user wishes to return to the parked vehicle and realizes that it has been misplaced, the record of transitions is used to locate the vehicle in the parking place, and to guide the user to the vehicle.

### Objects and Advantages

The fundamental objects and advantage of the car-finder is to make it possible to find one's car when:
One did not remember to note the vehicle's location while parking.
One did not realize that the vehicle was lost until after beginning to look for it.
One is not carrying any additional device specifically for this purpose.
The vehicle many be many yards (even several kilometers) away.

In the best mode of the car-finder, this capability is added to a device already carried by the user, such as a cell phone including GPS or other position finding technology. Cell phones are a good choice because such position finding capability is already required by law for 911 calls. In many cases, only software changes would be required to add this functionality, providing a saleable added benefit without recurring cost.

### BRIEF DESCRIPTION OF DRAWINGS

Out of graphical necessity, the drawings show specific choices from within the much broader scope covered by the following description and claims. These selections should be construed as illustrative, not as limiting beyond the full range of the following discussion and claims. Closely related figures have the same number but different alphabetic suffixes.

FIG. 1 shows the basic operation of the car-finder method, system, or device.

FIG. 2 shows the components of the car-finder device.

FIG. 3 shows alternative embodiments of the car-finder system or device.

FIG. 4 shows the car-finder device implemented in a GPS-capable cell phone.

FIG. 5 shows the car-finder system, with functions offloaded externally.

6 shows additional details of the display control.

7A shows the position sensor implemented using a receiver in the user device.

7B shows the position sensor implemented using a transmitter in the user device.

8A shows a default parking-location display.

8B shows a display for multiple parking locations.

8C shows a display for parking location in areas with no position signal.

### REFERENCE NUMERALS IN DRAWINGS

102 Automatically Monitor User Spatial Position/Velocity
104 Identify Drive/Walk Transition (i.e. parking locations)
106 User Request: “Where did I park”
108 Indicate Parking Positions
110 Select among Candidate Positions
112 Guide to Parked Car
202 Spatial Position Sensing, (1^{st} means)
204 Glitch filter
206 Velocity Determination, (2^{nd} means)
208 Motion Segmenter
210 Drive/Walk Transition Finder (3^{rd} means)
212 Memory
214 Parking Location Indicator
216 Output Device
300 Augmentation Sensors
302 Differential Position Sensor
303 Altimeter
304 Velocity Sensor
306 Orientation Sensor
308 Flux compass
310 Inertial Motion Sensor
320 User Selection (5^{th} means)
322 Guide-To Logic (6^{th} means)
324 Guidance Output
326 Positions-based Graphics Overlay (7^{th} means)
402 GPS-capable cell phone
404 Input
406 Display
408 GPS
410 Memory
412 Processor
414 Cell-Phone Function
416 Car-Finder Functions
502 External Systems
602 User-Velocity Direction of Display Device Orientation
604 Current User Position
606 Candidate Parking Locations
608 User Selection
610 Candidate Position Display
612 Guide-to Position Logic
614 Audible Prompts
616 Local-position Graphics Overlay
702 User Carried position sensor
704 External Position-Reference Transmitter
712 User-Device Transmitter
714 External Position-Determining Receiver (check claim wording)
802 Car-finder display
804 Guide-Vector for parking location
806 Time stamp for this parking location
808 Distance to Parking location
810 Marker for Parking Location
814 Time stamp of the next parking location not shown
816 Direction indicator to off-screen parking location
818 Time stamp for off-screen parking location
820 Marker and time stamp for alternative parking location
822 Time stamp for Structure Exit
924 Guide-Vector for Structure Exit
926 Time Stamp for Structure Exit
928 Marker for corresponding Structure entrance

### DETAILED DESCRIPTION

### Theory of Operation

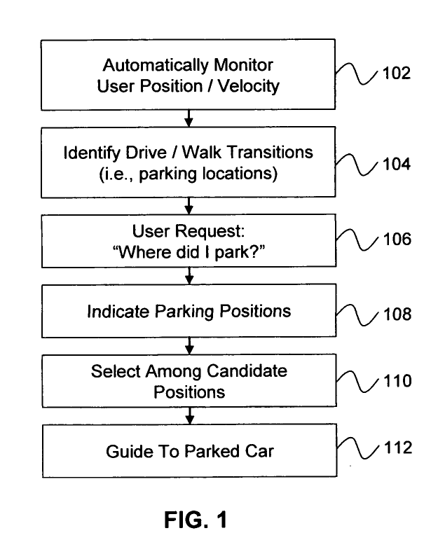

The fundamental operation of the device is shown in FIG. 1. The user's location is continually monitored. These locations are processed automatically to identify transitions between walking and driving, that is, parking spots. When one realizes that one's car has been misplaced, one activates the car-finder function added to the cell phone. The last parking spot is typically where the car was left. The user may also be provided information to confirm whether this is the correct location, and to select another among other recorded parking spots. The device then guides the user to the selected parking spot, and hence, to the vehicle.

### Operation of Invention—Preferred Embodiment

The operation of the device, method, and system is best summarized by walking through progressively more complex usage scenarios. Further details are discussed in the context of the individual figures.

Consider the following situation: a harried user drives loops around the extensive parking lots of a large mall, searching for a free spot, finally finds one, grabs it, and runs inside to complete some last minute holiday shopping. Hours later he emerges from the mall, only then realizing that he has no idea where in the acres of parking lots he has left his car.

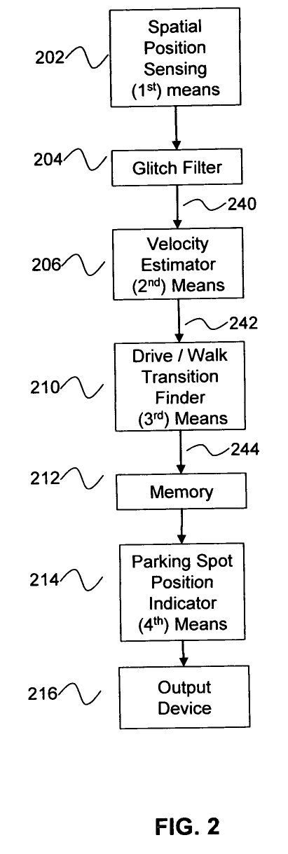

As per FIG. 1, the car-finder has been monitoring his position and velocity 102, without explicit action on his part, automatically identifying and recording his parking location. As he drove, his velocity ranged from road speeds to zero (stops and turns), and back to road speeds. The motion segmenter FIG. 2 208 groups these together. When he parks and leaves the car on foot, there is a stop, followed by motion at no more than walking speeds. The transition finder 210 automatically identifies the transition between these segments of motion 104 to mark the parking location.

When the user realizes that the car is lost he calls up 106 the car-finder display (FIG. 8A 802), which shows him where the car was left relative to his current position 810. As he walks toward it the guidance output 324 guides him to the car.

This level of functionality is sufficient to provide great value to many users, but is insufficient for some. Now, consider a more complicated situation.

A sales executive drives around the extensive parking lots of her local airport, finally finding an empty space and parking. She quickly gathers her luggage, and gets on a shuttle bus to the terminal. She flies to another city, takes a shuttle there to the rental car facility, and drives to a customer facility. The customer drives her to lunch, after which they return to the facility. At the end of the day, after meeting with several people in different buildings, she says her goodbyes and exits the building complex . . . in a completely different area than where she entered.

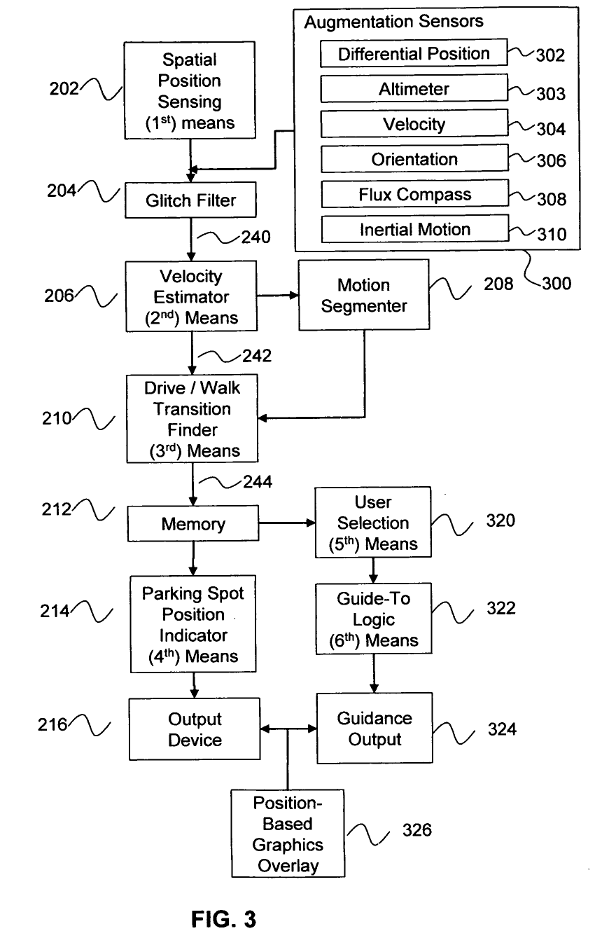

As in the previous case she activates the car-finder display. It shows her the most recent parking location. However, she notes from the time mark FIG. 8A 806 associated with that position that this is where she exited from the customer's car after lunch. She then requests a display of alternative locations FIG. 8B 820, and selects from among them FIG. 1 110, using the user selection means FIG. 3 320. She finds the next most recent (and next closest location), which is where she parked in the morning. She elects this location and is guided to it as detailed in the display figures.

She gets back into the rental car to drive back to the airport. On the way back she encounters extensive detours and gets a bit turned around. Her maps are in her briefcase in the trunk, but she doesn't need to bother getting them out. She activates the car-finder display again, selecting the spot where the parking shuttle dropped her off in the morning (this was also a transition from walking to driving). Now, knowing the direction to the airport, she's easily able to get back on track.

After she flies home, the parking shuttle takes her to back to the 50 acre parking lot . . . and the driver asks where she parked. In the rush to get out this morning, she didn't write it down as she usually would. Again she activates the car-finder function. This time the closest parking location is from the morning, where she left her car. Note that special care was required in forming drive/walk segments for this case, since the walk from the car to the shuttle might have been only a few meters. In this embodiment, the default display would include only location from earlier in the day, since the intervening locations were outside of the general area. She selects that and is able to tell the driver where to drop her off.

### Detail Discussion of Figures

### FIG. 1—Basic Operation of the Car-Finder Method, System, or Device

FIG. 1 shows the basic operation of one embodiment of the car-finder method, system, or device. First, automatically monitor the user position and velocity 102. This determines the position history not only of the user, but by implication, of any vehicle which the user has been driving or in which the user has been riding. The challenge is to differentiate between walking and not walking. This is done using the velocity history for the corresponding positions to identify drive/walk transitions (i.e., parking locations) 104. In the best mode this is done automatically as the user moves, and time-stamped parking locations thus identified are recorded in a memory for later retrieval, transparently to the user. The user's first explicit action is taken after realizing that he or she does not know how to get back to the vehicle or car. The user request 106 asks for help. In response, the device will indicate parking positions 108 to the user, that is, show the user where the car was left. In most cases there is a single clear answer (one parking spot), and we may immediately Guide to Parked Car 112. In some cases there may be more than one possible location, and the user should first select among candidate positions 110. Note that the indication of the parking position may be implicit. For example, providing guidance to the car (left, right, etc.) provides an indirect indication of position.

### FIG. 2—Components of the Car-Finder Device

FIG. 2 shows the components of the car-finder system or device in the preferred embodiment. Spatial position sensing 202 measures the position history not only of the user, but also by implication of any vehicle which the user has been driving or in which the user has been riding. The Glitch Filter 204 removes anomalies from this data to produce a smooth track consistent with the user motion. The particular mechanization of the glitch filter is dependent upon the spatial position sensing means selected, and appropriate methods are well known to those normally skilled in the art. In the best mode, here the simplest, velocity determination 206 is based directly upon the position time history. Other embodiments are discussed subsequently. The motion segmenter 208 groups consecutive positions together according to the mode of transportation, particularly identifying driving and walking by using the corresponding velocity. Stopped, or zero velocity, as well transitions through low velocities occur while walking and while driving, but are easily sorted out by context, into the walking and driving segments as described subsequently. The drive/walk transition finder 210, identifies positions where there was a transition from driving to walking. These are possible places where a vehicle has been parked. For purposes of this discussion a drop-off point, for example a place where the user was dropped off from a bus, would also be a possible parking location, although alternatives are presented subsequently. The memory 214 makes note of these parking locations, for later retrieval. In the preferred embodiment, when the user realizes that the vehicle has been misplaced and requests help, output is provided indicating the location of the most likely location where the vehicle was left via the output device 216.

### FIG. 3—Alternative Embodiments of the Car-Finder System or Device

FIG. 3 shows alternative embodiments of the car-finder system or device, adding to the components of FIG. 2, 202-216 which operate in the same manner as in FIG. 2 and are not addressed here. Sensing of positions and velocity is aided in some embodiments by augmentation sensors 300. A common enhancement is use of differential position sensing 302. This provides greater accuracy of relative motions over a small area, particularly in a satellite navigation solution, such as GPS. Another is direct velocity sensing 304, for instance using the Doppler shift from external sources. This improves velocity measurement and improves the quality of position measurements. An altimeter 303, whether relative or absolute, provides assistance particularly for identifying the correct floor of a multi-level parking structure, particularly when the position sensing signal is degraded or blocked. Orientation sensors 306 aid the fidelity of velocity and position data, as well as providing a reference for the display orientation as discussed subsequently. A flux compass 308 is a common orientation sensing device. Inertial Motion sensors 310, particularly orientation rate and linear acceleration may also be used in some embodiments to enhance position and velocity estimate fidelity. Methods of combining these sources are well known to those with normal skill in the art. For example, velocity may be derived primarily from inertial measurements, using position measurements to compensate for accumulated biases that produce rate errors, if at all. When there is more than one reasonable choice of parking location, a user selection 320 allows the user to pick among the available choices. This is most useful when using the Guide-to logic 322 to provide the user with directions to the vehicle via a guidance output 324.

In the case where this output is a display, it is desirable to provide a graphics overlay 326 providing a reference to orient the user to the vehicle location and its surroundings. This graphics may consist of a map, but since maps typically do not include parking lot layouts, it is sometimes more useful to use or add overhead imagery of the area.

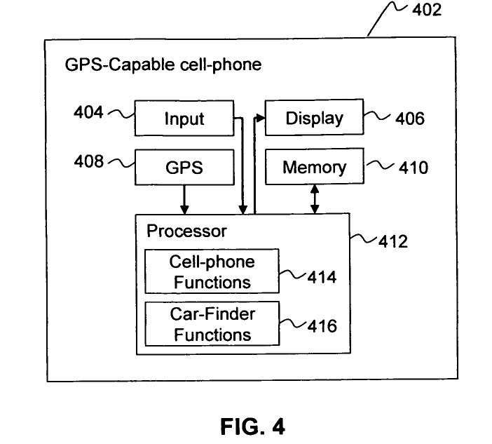

### FIG. 4—Car-Finder Device Implemented in a GPS-Capable Cell Phone

FIG. 4 shows the car-finder device embodied in a GPS-capable cell phone. A GPS-capable cell-phone device 402 includes the typical input device 404, display 406, GPS sensors 408, Memory 410, and Processor 412, with Cell-Phone Function 414 implemented in that processor. These components interact in the usual way when the device is used as a cell phone. However, these functions are further supplemented by Car-Finder Functions 416. These car-finder functions may be implemented according to FIG. 2.

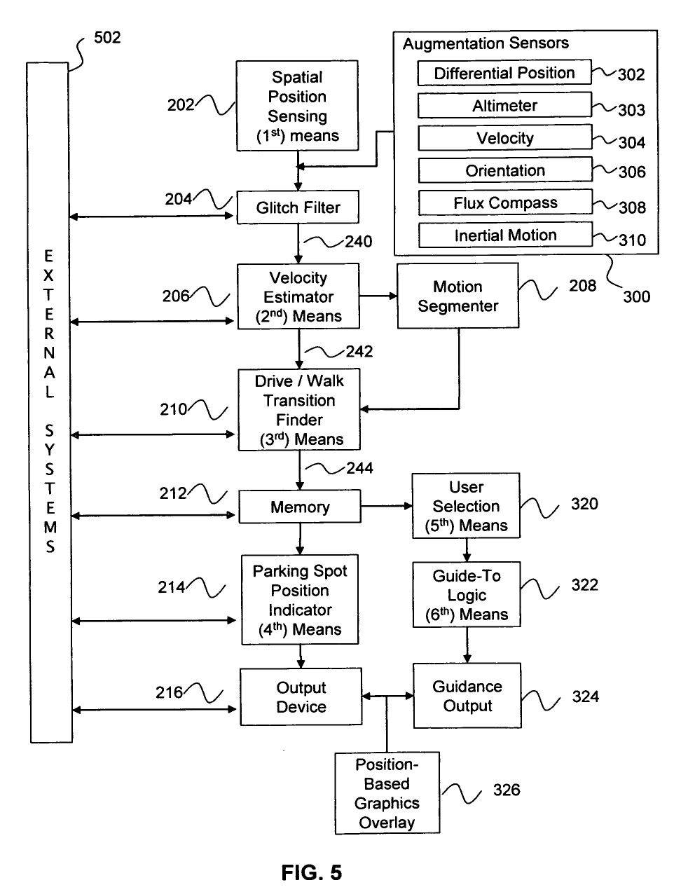

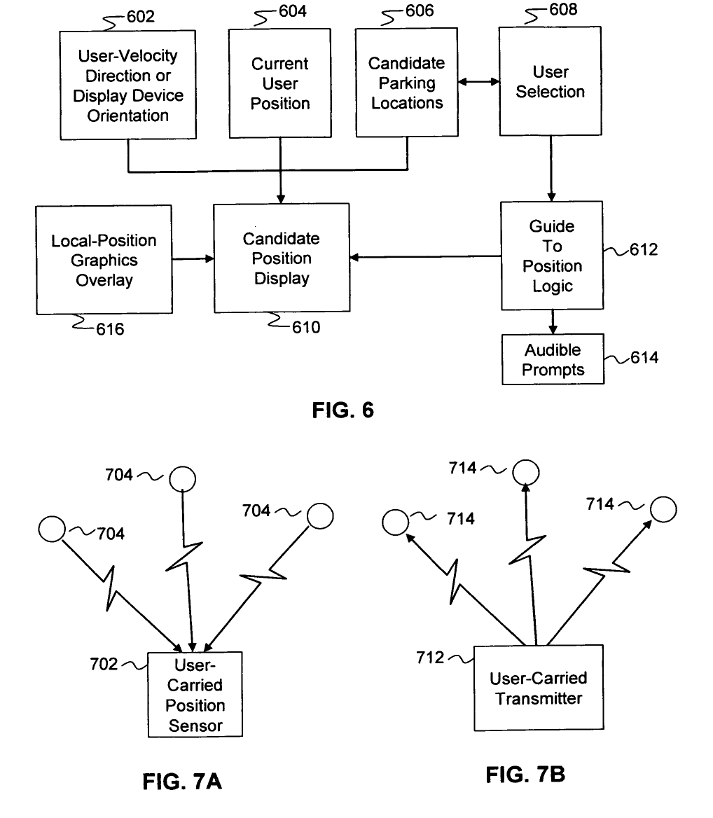

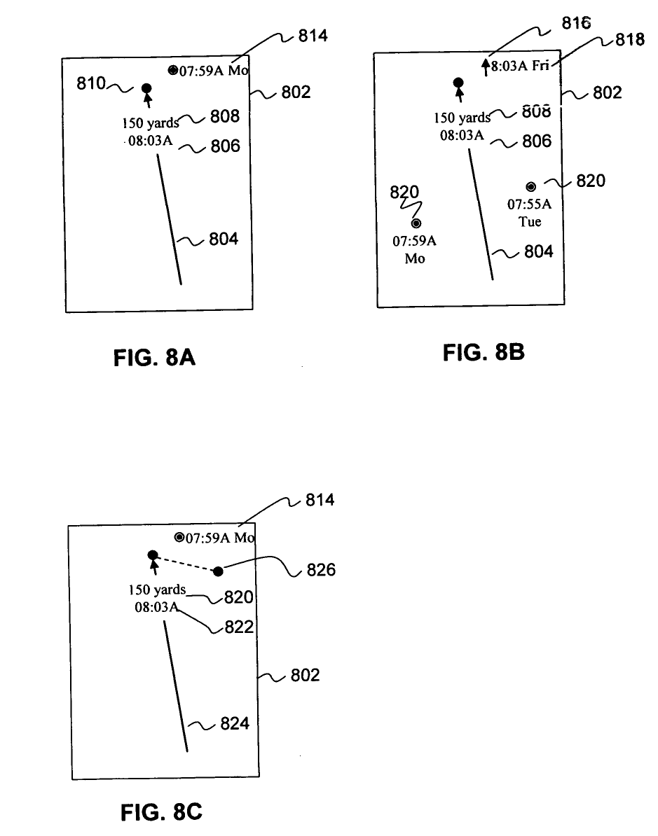

### FIG. 5—Car-Finder System, with Functions Offloaded Externally

FIG. 5 shows the car-finder system, with at least a portion of one function offloaded externally. The basic functional elements of the preferred embodiment are the same as in FIG. 2, 202-216, as are the augmentations of FIG. 3. They interact in the same manner, so that discussion is as in FIG. 2 and FIG. 3 are not repeated here. Any of these functions may be all or partially offloaded to an external system 502. The external system 502 then provides all of part of any of the indicated functions. An alternative reason for this choice of implementation is to control user access or billing, such a in a fee-for-user service.

### FIG. 6—Additional Details of the Display Control

FIG. 6 shows additional details of the display control, particularly highlighting the different pieces of information that are combined. In one embodiment the planar orientation in which the device is held (north, east . . . ) is used to determine the orientation of the location information on the candidate position display 610, for example, so that the display aligns with the actual orientation of the device. In general, this requires an orientation sensor, such as a flux compass 308. In another embodiment the user velocity direction is used to determine the preferred orientation 602. Since the device is typically held with “up” on the display facing the direction of motion, this has a similar effect without the use of a specific orientation sensor. In yet another, the display is always shown with the top of the screen in a preferred orientation (north, for example), like a map. In the preferred embodiment, the display method is selectable within the capabilities of the device. The current user position 604 and candidate parking location locations 606 are used to determine what is displayed. In the preferred embodiment, the display is scaled so that the current position and the candidate parking locations 606 currently selected appear on the display at the same time. Changing the user selection 608 from one parking location to another would change the display. In some embodiments a local-position graphics overlay 616 may be shown along with the parking location to provide the user with a frame of reference. This may include street map type data, overhead photos, or other information. In the preferred embodiment the display may also be driven by guide to position logic 612 providing visual cues to guide the user to the selected parking location. In alternative embodiments, visual cues may be supplemented or replaced with audile prompts 614 or other types of sensory cues.

### FIG. 7A—The Position Sensor Implemented Using a Receiver in the User Device

FIG. 7A shows the position sensor implemented using a receiver in the user device. A plurality of transmitters 704 provides signals encoded in such a way that the user device 702 may use them to triangulate its position. GPS and Magellan are typical examples of such configurations.

### FIG. 7B—Position Sensor Implemented Using a Transmitter in the User Device

FIG. 7B shows the position sensor implemented using a transmitter in the user device. One or more external receivers receive the signal and determine the transmitter location. This may be done using any combination of relative time of arrival, direction of arrival, of time to respond.

### FIG. 8A—Default Parking-Location Display

FIG. 8A shows a default parking-location display, for the preferred embodiment. The display 802 includes a bearing vector 804 showing the direction to the parking location 810. Text 808 indicates the distance. To aid in identifying whether this is the desired location, the display may show the time 806 at which the vehicle was left. When there are other possible parking locations in the memory, display text 814 may indicate that other locations are available, and the related times.

### FIG. 8B—Display for Multiple Parking Locations

FIG. 8B shows a display for multiple parking locations, which may be selected b the user. This adds marker and times for other candidate parking locations 820. An additional indicator 818 may show the time and direction of the next possible location not shown on the current display, allowing the use the option to zoom out to include that location as well.

### FIG. 8C—Display for Parking Location in Areas with no Position Signal

FIG. 8C shows a display for parking location in areas with no position signal. When the car is parked in a location where the device is unable to measure position, such as a buried garage when using a car-finder with GPS measurements and no inertial motion supplement, the car-finder can not mark the specific parking location. In the preferred embodiment it marked the position where the location signal was recovered, showing an additional marker 826 connecting this with the point where the position signal was lost (typically the entrance to the garage).

### Alternative Embodiments

A reader normally skilled in the art will certainly see many variations possible in the mechanization and approach. The following discussion highlights only a few of them, and is intended as illustrative, not restrictive.

The preferred embodiment of this device is in a GPS-capable cell phone FIG. 4, since this is a device which would normally be carried with the user anyway, with the power on. Hence, no additional equipment is required. However, this functionality could equally well be placed in any other piece of personal electronics. Likewise another position transponder systems FIG. 7A, such as LOARAN or the European Magellan might be used in place of GPS. Alternatively, an external positioning system FIG. 7B based on signals transmitted from the car-finder device might be used. This would include, for example, cell-tower based systems. These alternatives need not be mutually exclusive: position information interpreted by the user device may be supplemented with information received from external systems FIG. 5.

Another alternative is adding sensors 300 to the device or system to supplement the positioning information. A compass for direction, inertial sensors, and altimeter are typical. These allow positioning accuracy in area where the usual signals (Such as GPS) are blocked (such as inside large parking structures).

As per FIG. 5, all or part of the functionality of the device may be offloaded to an external system. For example, in the case where signals from the device are used to determine position, this is done through interaction with external systems. These systems may also handle all of part of the processing and data storage. A particular supplement in loading a graphics overlay FIG. 3 326 giving context to the current location. This might consist of a parking lot layout, map of surrounding roads, or overhead imagery, to name a few.

In the simplest case the updating the location display FIG. 8A as the user moves would guide the user to the parked vehicle. This could be supplemented with other displays, or various audible prompts 614. It is obvious that may other variations on the display and user controls may be used, without fundamentally changing the essence of the method or device. As one example, a “snail trail” showing the user's previous motion, while of limited utility by itself, might provide useful supplemental data for aiding memory or orientation. Also, obvious variations on the interface would provide full capability to sight impaired users.

There are many of different ways in which candidate parking locations may be identified from the measured data. A simple approach would use a fixed threshold, such as 6 mph, to identify driving segments. More elaborate methods based on adaptive processing, more detailed analysis of localized motion, historical patterns, enhanced using of ancillary sensor information 300, and so on can also be used.

Motion may be classed into more categories, beyond simply walking and driving. Or, parking location may be identified without directly segmenting the data. While not required for the basic application, it is obvious that significant additional intelligence can be used to pre-sent the most likely parking spot of interest, or to filter out motions and behaviors less likely to correspond to parking, such as stepping onto and walking along a fast-moving passenger conveyor (which might cause sufficient speed to be classified as driving in a simpler system).

Processing steps may be performed in a different order, combined, or further separated. All such variations are included within the scope of this description, as long as the basic functions identified here are provided.

The car-finder method may be applied to vehicles other than personal cars. As discussed, it applies to rental vehicles. It can also be used for boats or other conveyances.

The method may be supplemented by communication with devices in or related to the vehicle. For example, if the car has a GPS unit, it may be queried. Alternatively, a signal from the car's locking key-fob may be monitored to aid in identifying parking locations.

The method of device need not be used by the driver of the vehicle. For example, it may be used by a passenger. Or, one person may give it to another to help them find a previously placed vehicle. In this case, both people constitute “the user”.

The locator need not be explicitly carried by the user. For example, it might be in a briefcase or bag, either built in or placed there.

It also is not necessary that the user explicitly request information. This information can be automatically displayed, on a continuous basis, or based upon an autonomous decision.

In simplest form, the car-finder may automatically select the most likely parking location and report only that. In other embodiments the user may be provided with means to examine and select from multiple possible alternatives 320. It is obvious that enhanced measurements and rules may be used to better identify the most likely candidate parking location. For example, while the user may have parked at a position closer to the current location several days ago, the location that is only one day old and fifty yards away is more likely to be the desired choice.

### Conclusion Ramifications and Scope

This method provides a substantial improvement in the state of the art for finding misplaced vehicles whereby the user's vehicle can be located even when:
1) the user does not remember to take any explicit action to mark the vehicle's position when parking,
2) the user adds no additional device to the vehicle,
3) the user does not carry an addition device not normally on their person (where this functionality is built into a GPS-capable cell phone),
4) the vehicle may hundreds of meters (or even several Km) away from the current location.

The car-finder has been described with reference to the preferred and certain alternative embodiments. Obviously, modifications and alterations will occur to others upon reading and understanding the preceding detailed description. It is intended that the invention be construed as including all such modifications and alternatives insofar as they come within the scope of the appended claims or the equivalents thereof.

1. A device for finding a parked vehicle from which the user has previously exited, comprising:
(a) first means 202 for sensing at least a relative geo-location of said device,
(b) second means 206 for determining the velocity at these locations,
(c) third means 210 for identifying transitions from driving to walking, or candidate parking locations, based at least partially upon these velocities,
(d) a memory 212 configured to record at least the position of one such candidate parking location,
(e) fourth output means 214 configured to indicate the position of at least one candidate parking location.

2. The device of claim 1, or car-finder, wherein the car-finder functionality is implemented at least partially via software enhancement to a GPS-capable cell-phone 402,
whereby said cell-phone, which is normally carried by said user with its power turned on, provides car-finder functionality,
whereby said user need not carry or supplement said vehicle with any additional device to perform the car-finder function,
whereby said user need not take any specific action to capture the location of the vehicle,
and whereby the user is able to determine the position of the vehicle after determining that it has been misplaced, even when it may have been misplaced over an area beyond the practical limits of visual or auditory cues from the vehicle.

3. The device of claim 1 wherein the first, or position sensing, means utilizes external transmitting geo-location references 704,
whereby the device utilizes position sensing systems such as GPS, Magellan, or LORAN.

4. The device of claim 3 further comprising at least one supplemental measurement device selected from the set consisting of differential position sensor, inertial sensor, orientation sensor, and flux compass 302-110,
whereby the fidelity of the position velocity data is enhanced and the accuracy of the park/walk position determination is improved.

5. The device of claim 1 further comprising:
(a) means for said user to select from among candidate parking locations 320,
(b) means for guiding said user from the current position to the selected parking location via sensory cues that nominally change as the user moves 322.

6. The device of claim 1 wherein at least one component of claim 1 (a)-(f) is implemented at least partially via communications with some external system 502,
whereby device functions may be enabled or augmented by the external systems,
and whereby the car-finder function may be controlled via those systems.

7. The device of claim 6 further comprising a seventh means for superimposing candidate parking locations on graphics of the current location, derived at least partially from an external system 326,
whereby parking locations are superimposed over a reference such as a map or aerial photo to provide an additional frame of reference for said user.

8. The device of claim 6 wherein said first means for position sensing comprises:
(a) a user-device transmitter 712 providing signals configured to be received by a one or more external receivers 714, from which received signals the location of the transmitter is determined,
whereby the car-finder device operates with cell-tower based or other comparable geo-location systems.

9. A method for finding a parked vehicle from which the user has previously exited, comprising the following steps:
(a) automatically monitoring the nominal spatial position and velocity of said user 102,
(b) based at least partially upon said position and velocity, identifying the location of one or more transitions from driving to walking 104,
(c) indicating to said user the position of said location, or parking place 108,
whereby places where a vehicle was exited to travel on foot, that is, parking locations, are identified,
whereby said user need not take any specific action to capture the parking location,
and whereby the user is able to retrieve the parking location after determining that the vehicle has been misplaced, even when it may have been misplaced over an area beyond the practical limits of visual or auditory cues from the vehicle.

10. The method of claim 9 further comprising:
(a) carrying a device nominally with the user that enables sensing of the user position 202.

11. The method of claim 9 further comprising:
(a) overlaying graphics defining references for the current location 610 over a display of at least one parking location,
whereby the user may be aided with map or over-head images to provide a spatial reference.

12. The method of claim 9 further comprising:
(a) providing means for said user to select 608 from among multiple possible parking locations 606,
(b) guiding said user to the selected location as said user moves.

13. The method of claim 12 further comprising:
(1) providing audible prompts to direct the user to the selected parking location 614.

14. A system for finding a parked vehicle from which the user has previously exited, comprising the following:
(a) first means 202 for sensing at least a relative geo-location of said user,
(b) second means 206 for determining the velocity at these locations,
(c) third means 210 for identifying transitions from driving to walking, or candidate parking locations, based at least partially upon these velocities,
(d) a memory 212 configured to record at least the position of one such candidate parking location,
(e) fourth output means 214 configured to indicate the position of at least one candidate parking location.

15. The system of claim 14 wherein said first means of position sensing comprises a sensor nominally carried by said user 202.

16. The system of claim 14 wherein said first mean of position sensing comprises:
(a) a transmitter nominally carried by the user 712,
(b) at least one external receiver 714 configured to utilize the received signals to determine the user location.

17. The system of claim 14 further comprising at least one supplemental measurement device nominally carried by the user and selected from the set consisting of differential position sensor, altimeter, inertial sensor, orientation sensor, and flux compass 302-110,
whereby the fidelity of the position velocity data is enhanced and the accuracy of the park/walk position determination is improved.

18. The system of claim 14 further comprising:
(a) an input device configured to allow said user to select from among at least one candidate parking locations 320,
(b) means for guiding said user from the current position to the selected parking location via sensory cues that nominally change as the user moves 322.

19. The system of claim 18 wherein said means for guiding comprises a display, nominally carried by said user, that provides an indication of the relative position of the parking location relative to the current position what is nominally updated as said user moves.

20. The system of claim 18 further comprising a display configured to overlay graphics of the current area 326,
whereby parking locations are superimposed over a reference such as a map or aerial photo to provide an additional frame of reference for said user.
